(19) United States
(12) Patent Application Publication
(10) Pub. No.: US 2020/0102748 A1
(43) Pub. Date: Apr. 2, 2020

(54) A STEEL BEAM EMBODIMENT WITH REINFORCED LOWER HEAD

(71) Applicant: ONESTEEL YAPI TEKNOLOJILERI LTD. STI., Istanbul (TR)

(72) Inventor: Irfan Saydar, Istanbul (TR)

(21) Appl. No.: 16/612,750

(22) PCT Filed: Jun. 7, 2017
(86) PCT No.: PCT/TR2017/050255

§ 371 Date: Nov. 12, 2019

(30) Foreign Application Priority Data
May 11, 2017 (TR) 2017/06984

(51) Int. Cl. E04C 3/294; B28B 23/04; E04C 3/06; E04C 3/10

(52) U.S. Cl. CPC E04C 3/294; B28B 23/04; E04C 2003/0413; E04C 3/10; E04C 3/06

(57) ABSTRACT

The present invention is a steel beam (10) having a steel profile (20) comprising a lower head (23) and an upper head (21) which is substantially parallel to said lower head (23), characterized by comprising cables (42) provided under the steel profile (23) along the length of the steel profile (20) and to which tensioning process is applied, and a lower reinforcing concrete (40) embodied by the steel profile (20) lower head (23) in the form of a layer in a manner covering the cables (42) so as to fix said cables (42) at their positions and tensions.

### TECHNICAL FIELD

The present invention relates to a steel profile embodiment whose lower head is reinforced by providing pre-tensioning or post-tensioning force by means of concrete support.

### PRIOR ART

Ferro-concrete upper furnishings are used in composite form together with steel profiles, in order to provide reduction in costs of steel profile. Said composite beams are formed by steel profiles, studs connected to the upper heads of the steel profiles by means of welding and ferro-concrete upper furnishing poured onto the studs. In the openings where the distance between the concrete feet is lower than 15-20 m, classical composite steel profile beams are sufficient to resist loads, however, in cases where the openings are bigger than 15-20 m and where the movable loads are bigger than 1000 kg/m², costs increase. Moreover, under opening values and under loads, excessive pressure and shearing load are exerted onto the upper furnishings, and this reduces the proportion of composite, and increase in inertia, which will reduce deflection against increase in opening, cannot be obtained. The steel profiles, remaining under the ferro-concrete furnishing, are mostly protected by consuming additional money for fire protection.

In cases where the openings are big, pre-tensioning or post-tensioning systems are used for providing usage of the steel profiles in a low-cost manner. Tensioning processes are applied by applying tensioning force to the lower head of the simple steel profile beams. In the pre-tensioning processes already applied, the force is directly transferred to the lower head. Such an application is realized by means of directly welding the tensioned pre-tensioning ropes to the lower head or by means of tensioning the lower head and by means of obtaining welded constructed steel profile. For the openings bigger than 25-30 m, the pre-tensioned lower head cannot carry the pressure load thereon in a low-cost manner. The cross section of the lower head shall be increased in size due to the effect of pressure head twist. Moreover, the ropes used in the pre-tensioning process or the tensioned lower head elements may be subject to corrosion and fire and they may be affected by heat differences. Thus, due to these conditions, additional maintenance and repair cost may occur.

In the post-tensioning processes already applied, tensioning force is exerted after the assembly studies of the lower head are finished. In applications where the openings are 50-70 m, the steel profile cross sections can be in the form of a box. In usage of such type of steel profile, the post-tensioning cables are positioned in a linear or curved form under or in (on) the lower head of the steel profile. Such type of steel beam lower heads carry pressure forces in an easier manner and they have a high cost. Additionally, the post-tensioning ropes, which are the most critical elements of the carrier system, are affected by corrosion, fire and heat differences and they need additional maintenance and repair costs.

These applications are in the form of ferro-concrete pre-tensioned beam and ferro-concrete post-tensioned furnishing. Ferro-concrete pre-tensioned beams do not provide low-cost results at concrete foot openings between 25-30 m, and they cannot be technically applied in cases where the openings are over 35 m. In ferro-concrete post-tensioned furnishings, in the application step, the whole system shall be supported with the mold and scaffold system during the setting duration. Due to this, the construction durations and costs increase. This is not applicable in viaducts whose concrete foot length is big. Moreover, in case this system is used in city centers, additional traffic load occurs due to the scaffold system.

As a result, because of all of the abovementioned problems, an improvement is required in the related technical field.

### BRIEF DESCRIPTION OF THE INVENTION

The present invention relates to concrete reinforced steel beam embodiment whose lower head is reinforced by means of pre-tensioning or post-tensioning process, in order to be used in furnishing processes under heavy loads at big intervals, for eliminating the above mentioned disadvantages and for bringing new advantages to the related technical field.

The main object of the present invention is to provide a steel beam embodiment whose production and assembly steps are accelerated and whose cost is reduced.

Another object of the present invention is to provide a steel beam embodiment which reduces high production and maintenance costs occurring in embodiments like viaduct where the openings are wide.

Another object of the present invention is to provide a steel beam embodiment which has big openings and which eliminates the deflection problem which occurs under heavy loads.

Another object of the present invention is to provide a steel beam embodiment where protection from fire risk is provided in a low cost manner.

In order to realize all of the abovementioned objects and the objects which are to be deducted from the detailed description below, the present invention is a steel beam having a steel profile comprising a lower head and an upper head which is substantially parallel to said lower head. Accordingly, said steel beam is characterized by comprising cables provided under the steel profile along the length of the steel profile and to which tensioning process is applied, and a lower reinforcing concrete embodied by the steel profile lower head in the form of a layer in a manner covering the cables so as to fix said cables at their positions and tensions.

In another preferred embodiment of the invention, in order to transfer the tensioning force, which exists on said cables, to the steel profile by means of said lower reinforcing concrete, embedded studs are connected in a manner extending under the lower head.

In another preferred embodiment of the invention, the lower reinforcing concrete comprises a fixture through which cables are passed and positioned, and cable guides positioned inside said fixture.

In another preferred embodiment of the invention, connection elements are provided which are connected onto said lower head.

In order to realize all of the abovementioned objects and the objects which are to be deducted from the detailed description below, the present invention is a reinforcing method for a steel beam embodiment having a steel profile comprising a lower head and an upper head which is substantially parallel to said lower head. Accordingly, the subject matter steel beam reinforcing method is characterized by comprising the steps of:
a) Connecting embedded studs under the lower head of the steel profile,
b) Positioning fixture and cables inside a mold system,
c) Positioning the steel profile on the mold system such that the embedded studs are placed into said fixture,
d) Applying pre-tensioning process to said cables by means of pre-tensioning apparatus,
e) Fixing the tensions and positions of said cables and applying lower reinforcing concrete to a concrete chamber provided in the mold system,
f) Removing the pre-tensioning apparatus and releasing the cables,
g) Transferring the tensioning forces, existing in the fixed cables and in the lower reinforcing concrete, to the steel beam through the embedded studs.

In a preferred embodiment of the subject matter method, during the production step, in order to prevent the deflection in the steel profile which occurs due to the fixture and the cables, the positioning arms, positioned in the mold system in step (b), are placed to the connection elements.

In a preferred embodiment of the subject matter method, the lower reinforcing concrete, obtained in said step (e), is waited for setting before the mold system is removed.

In a preferred embodiment of the subject matter method, in said step (f), the released cable ends are cut through the outer surface of the lower reinforcing concrete.

In a preferred embodiment of the subject matter method, in said step (d), in case the pre-tensioning process is not applied, post-tensioning process is applied after the assembly of the steel beam.

In a preferred embodiment of the subject matter method, all of said steps are applied in both simple beam and continuous beam applications.

In a preferred embodiment of the subject matter method, all of said steps are applied in the form of pre-tensioning or post-tensioning on the upper head in continuous beam embodiments.

### BRIEF DESCRIPTION OF THE FIGURES

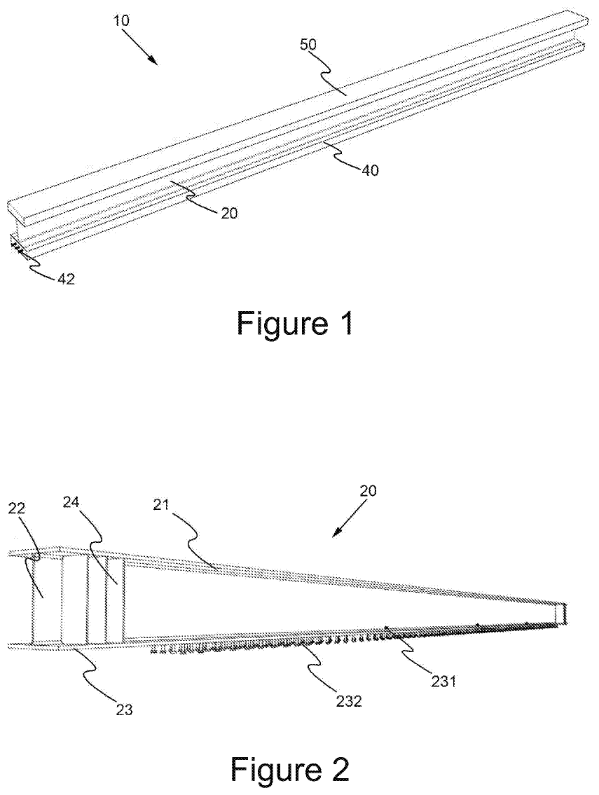

In FIG. 1, the general view of the steel beam whose lower head is reinforced is given.

In FIG. 2, the general view of the steel profile formed by using constructed or ready-made I-H profile is given.

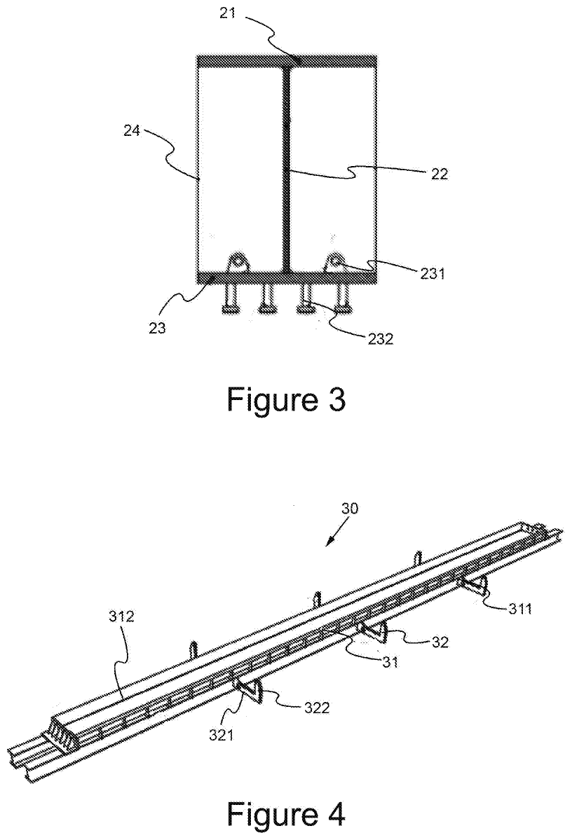

In FIG. 3, the frontal perspective view of the steel profile is given.

In FIG. 4, the general view of the mold system is given.

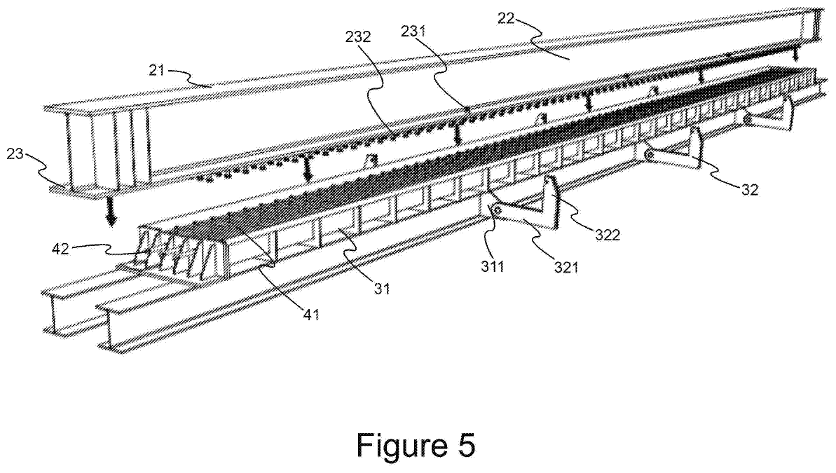

In FIG. 5, the general view of the steel profile connected to the mold system is given.

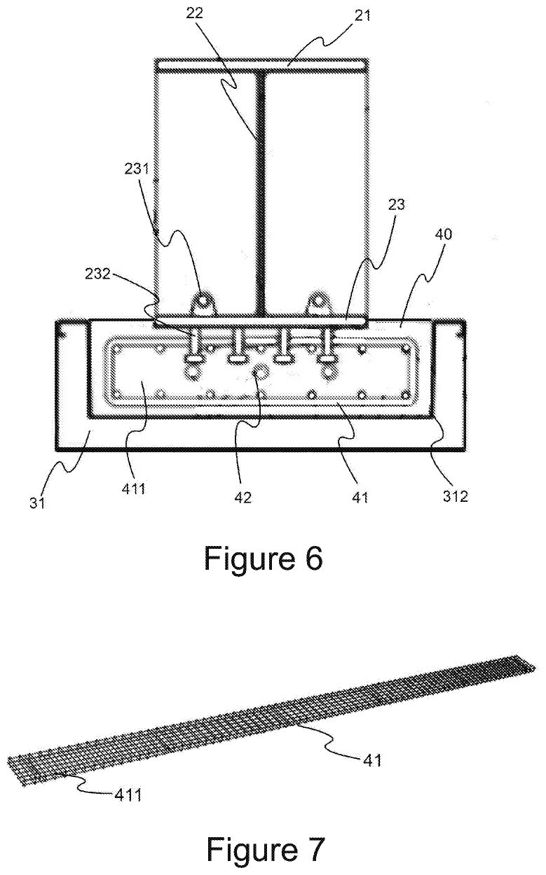

In FIG. 6, the frontal perspective view of the steel profile connected to the mold system is given.

In FIG. 7, the general view of the fixture is given.

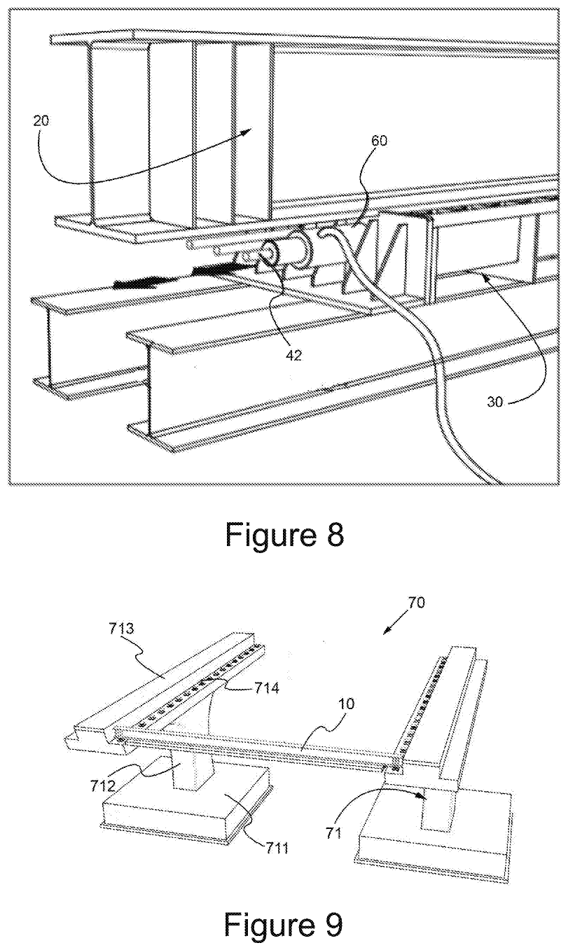

In FIG. 8, the general view of the application of the pre-tensioning process is given.

In FIG. 9, the general view of the exemplary application viaduct is given.

### REFERENCE NUMBERS

10 Steel Beam
20 Steel Profile
   21 Upper Head
   22 Body
   23 Lower Head
      231 Connection Element
      232 Embedded Stud
   24 Reinforcement Plate
30 Mold System
   31 Mold Carcass
      311 Connection Plate
      312 Concrete Chamber
   32 Positioning Arm
      321 Mold Connection Section
      322 Profile Connection Section
40 Lower Reinforcing Concrete
   41 Fixture
      411 Cable Guide
   42 Cable
50 Upper Reinforcing Concrete
60 Pre-Tensioning Apparatus
70 Example Application Viaduct
   71 Carrier System
      711 Single Base
      712 Carrier Column
      713 Carrier Beam
      714 Sliding Support

### DETAILED DESCRIPTION OF THE INVENTION

In this detailed description, the subject matter steel beam (30) is explained with references to examples without forming any restrictive effect only in order to make the subject more understandable.

With reference to FIG. 1, the subject matter steel beam (10) comprises a steel profile (20) and a lower reinforcing concrete (40) provided under said steel profile (20) and an upper reinforcing concrete (50) provided on the steel profile (20). The steel profile (20) comprises an upper head (21) and a lower head (23) extending substantially parallel to said upper head (21), a body (22) embodied between said lower head (23) and said upper head (21), and reinforcement plates (24) placed in a spaced apart manner in a manner interrupting the extension axis of the body (22) along the length of the steel profile (20). There are connection elements (231) which are connected at specific intervals on the lower head (23). Pluralities of embedded studs (232) are connected under the lower head (23) in a manner extending downwardly. The lower reinforcing concrete (40) is essentially a concrete layer, and it comprises a fixture (41) embodied in web form and cable guides (411) positioned inside said fixture (41). In said cable guides (411), cables (42) are provided along the length of the fixture (41).

In order to form the steel beam (10), the integration of the steel profile (20) and the lower reinforcing concrete (40) is realized by using a mold system (30). In this direction, said mold system (30) basically comprises a mold carcass (31) and positioning arms (32) connected at the edges of said mold carcass (31). The mold carcass (31) comprises connection plates (311) where said positioning arms (32) are connected at the edges thereof. Along the length of the mold carcass (31), a concrete chamber (312) is embodied. The positioning arm (32) comprises a mold connection section (321) connected to said connection plates (311) and a profile connection section (322) embodied at the continuation of said mold connection section (321). Said profile connection section (322) is guided in said connection elements (231).

In order to bring the steel profile (20) and the lower reinforcing concrete (30) into integrated form, first of all, the fixture (41) is placed onto the mold carcass (31) together with the cable guides (411), and afterwards, the cables (42) are passed between the cable guides (411) and they are placed into the fixture (41). Here, as cable (42), said embodiments are pre-tensioning bundles if pre-tensioning process is to be realized in accordance with the selected tensioning system, and said embodiments are post-tensioning cables if post-tensioning process is to be realized. In case post-tensioning process is to be realized, the cable pipes are positioned inside the fixture together with post-tensioning cables. After placement of the fixture (41) and the cables (42), the lower head (23) is positioned on the mold carcass (31) such that said embedded studs (232) are placed into the fixture (41). After this positioning, in order to prevent the deflection which may occur in the steel profile (20), the profile connection sections (322) of the positioning arms (32) are placed to the connection plates (231). Pre-tensioning process is realized after this step. In the pre-tensioning process, after the steel profile (20) is positioned on the mold carcass (31), pre-tensioning apparatus (60) are connected to the cables (42), and tensioning force is applied onto the cables (42). When the cables (42) reach the desired tensioning force, concrete is poured onto the fixtures (41) and the cables (42) in a manner filling the concrete chamber (312). Thus, a lower reinforcing concrete (40), comprising the fixture (41) and the cables (42), is obtained in a manner covering the embedded studs (232). Since the embedded studs (232) are provided in the lower reinforcing concrete (40), the pre-tensioning force is transferred from the cables (42) to the lower head (23) by means of the adherence occurring. After the concrete is poured, the lower reinforcing concrete (40) is waited for setting, and afterwards, the tensioning force existing in the cables (42) is removed. After this step, the lower reinforcing concrete (40) is lifted and carried by means of the pre-tensioning force. In order to facilitate assembly, the lower reinforcing concrete (40) can become the face at the beginning and end of the steel profile (20) and at the same time, it can be left inside with the required proportion.

Different steel profile (20) types can be used in order to be used in cases where the openings and loads are different. Although I-H profile application is foreseen as standard, when required, steel profiles (20) like box, planar cage, triangular or square space cage, etc. can also be used. In cases box cross sectioned steel profiles (20) are used, the lower reinforcing concrete (40) can be positioned outside of the steel profile (20) or it can be positioned inside the steel profile (20). In case the lower reinforcing concrete (40) is embodied inside the steel profile (20), the tensioning process can be realized in a linear manner or in a curved manner according to the momentum curve. In curved solutions, post-tensioning cable can be used when required from the support to the other support in outer medium, except the lower head (23) lower reinforcing concrete (40).

The steel beams (10) can be single or they can be produced in the form of double and triple groups depending on the assembly method to be selected and depending on the openings. In these applications, the lower reinforcing concrete (40) can be poured together for all steel profiles (20) provided side by side. These applications, where pluralities of steel profiles (20) are used, provide the sensitivity in the assembly step particularly in big openings, and these applications provide the assembly application to be more rapid and to have lower-cost. Besides, the since the cables (42) are embedded into the lower reinforcing concrete (40), the cables (42) are not affected by heat changes and by corrosion, and depending on this, the maintenance process intervals can be lengthened and the maintenance costs are reduced.

For the continuous beam solutions, on the steel profile upper head (21), the required precautions are taken and the upper reinforcing concrete (50) is poured in order to realize pre-tensioning or post-tensioning application inside the upper head fixture region.

As an example to a structure where the subject matter steel beam is applied, in FIG. 9, the general view of an example application viaduct (70) is given. Said example application viaduct (70) comprises carrier systems (71) provided side by side and steel beams (10) whose subject matter lower head is reinforced positioned in a manner extending on said carrier systems (71). The steel beams (10) are covered by the lower reinforcing concrete (40) and by the upper reinforcing concrete (50). The carrier system (71) essentially comprises a single base (711) embedded to the floor, a carrier column (710) provided on said single base (711), a carrier beam (713) where a path line is seated through specific points on said carrier column (710), and sliding supports (714) connected onto said carrier beam (713).

The protection scope of the present invention is set forth in the annexed Claims and cannot be restricted to the illustrative disclosures given above, under the detailed description. It is because a person skilled in the relevant art can obviously produce similar embodiments under the light of the foregoing disclosures, without departing from the main principles of the present invention.

1. (canceled)

2. (canceled)

3. (canceled)

4. (canceled)

5. A reinforcing method for a steel beam (10) embodiment having a steel profile (20) comprising a lower head (23) and an upper head (21) which is substantially parallel to said lower head (23), characterized by comprising the steps of:
a) Connecting embedded studs (232) under the lower head (23) of the steel profile (20),
b) Positioning the fixture (41) and cables (42) inside a mold system (30),
c) Positioning the steel profile (20) on the mold system (30) such that the embedded studs (232) are placed into said fixture (41),
d) Applying pre-tensioning process to said cables (42) by means of pre-tensioning apparatus (60),
e) Fixing the tensions and positions of said cables (42) and applying lower reinforcing concrete (40) to a concrete chamber (312) provided in the mold system (30),
f) Removing the pre-tensioning apparatus (60) and releasing the cables (42),
g) Transferring the tensioning forces, existing in the fixed cables (42) and in the lower reinforcing concrete (40), to the steel beam (10) through the embedded studs (232).

6. A steel beam (10) reinforcing method according to claim 5, wherein during the production step, in order to prevent the deflection in the steel profile (20) which occurs due to the fixture (41) and the cables (42), the positioning arms (32), positioned in the mold system (30) in step (b), are placed to the connection elements (231).

7. A steel beam (10) reinforcing method according to claim 5, wherein the lower reinforcing concrete (40), obtained in said step (e), is waited for setting before the mold system (30) is removed.

8. A steel beam (10) reinforcing method according to claim 5, wherein in said step (f), the released cable (42) ends are cut through the outer surface of the lower reinforcing concrete (40).

9. A steel beam (10) reinforcing method according to claim 5, wherein in said step (d), in case the pre-tensioning process is not applied, post-tensioning process is applied after the assembly of the steel beam (10).

10. A steel beam (10) reinforcing method according to claim 5, wherein all of said steps are applied in both simple beam and continuous beam applications.

11. A steel beam (10) reinforcing method according to claim 5, wherein all of said steps are applied in the form of pre-tensioning or post-tensioning on the upper head (21) in continuous beam embodiments.
